(19) United States
(12) Patent Application Publication
(10) Pub. No.: US 2025/0265494 A1
(43) Pub. Date: Aug. 21, 2025

(54) REINFORCEMENT LEARNING FOR COMPUTATIONAL GRAPHS

(71) Applicant: Etsy, Inc., Brooklyn, NY (US)

(72) Inventors: Andrew Stanton, Brooklyn, NY (US); Arthur Maciejewicz, Brooklyn, NY (US); Stephen Balogh, Brooklyn, NY (US)

(21) Appl. No.: 18/859,337

(22) PCT Filed: Apr. 28, 2023
(86) PCT No.: PCT/US2023/020470

§ 371 Date: Oct. 23, 2024

Related U.S. Application Data
(60) Provisional application No. 63/336,953, filed on Apr. 29, 2022.

(51) Int. Cl. G06N 20/00; G06F 16/245

(52) U.S. Cl. CPC G06N 20/00; G06F 16/245

(57) ABSTRACT

Methods, systems, and apparatus, including computer programs encoded on a computer storage medium, that receives data representing a computational graph including multiple nodes and directional edges unidirectional connecting two neighboring nodes and receives training data including a reward function for a reinforcement learning model. A value function of the reinforcement learning model is initialized. For each node that is not a terminal node in the plurality of nodes, the value function of the reinforcement learning model is determined. The determination includes: updating the value function based on (i) a respective directional edge that starts from the node and connects a succeeding node and (ii) the reward function; determining that the updated value function converges, and in response, providing the updated value function as the value function. The value function for processing a user query is stored and used to process the user query.

### BACKGROUND

This specification relates to processing a user query for information, e.g., on an exchange platform, and in particular, relates to processing the user query along a computational graph using a machine learning model.

An example exchange platform enables exchange of goods, content, and services between end users and providers. Providers can list or provide their goods, contents, and services on the exchange platform, and end users obtain the goods, content, and services from the providers via the exchange platform.

Reinforcement learning systems can be deployed in such platforms to facilitate various operations of the platform, including, e.g., search and retrieval of information, e.g., information related to items provided on the platform. In a reinforcement learning system, an agent generally interacts with an environment by performing actions that are selected by the reinforcement learning system in response to receiving observations that characterize the current state of the environment. Some reinforcement learning systems select the action to be performed by the agent in response to receiving a given observation in accordance with an output of a neural network.

### SUMMARY

This specification relates to processing a user query on a computing platform using machine learning models. In more detail, some implementations described herein relate to user query processing in a computational graph framework aided by reinforcement learning techniques. This includes training and using a reinforcement model for generating output data including one or more predictions for a user input (e.g., a user query). For example, in the context of an exchange platform, a prediction can include an item listing corresponding to the user query. In addition, one of the embodiments described herein deploys a random walk sampling technique formulated based on implicit user feedback information, and performs random walk sampling on a computational graph representing a query-listing relation, to generate multiple candidate trajectories connecting query nodes (or initial nodes) and listing nodes (or terminal nodes).

Particular embodiments of the subject matter described in this specification can be implemented to realize one or more of the following advantages. For example, the innovations described in this specification improves accuracy for processing a user query. Using a reinforcement learning model, the system can infuse historical data as context when processing a user query using a computational graph. In addition, the system can bias weight values for directional edges based on negative interactions, which further improves the accuracy compared to techniques that only consider positive interactions. In this document, positive interactions include clicking, adding to a cart, purchasing an item in a listing or any other interactions expressing interest in an item, and negative interactions include scrolling pass or indicating a lack of interest in the listing of an item. The system further includes a scoring function for a sampled random walk, where the scoring function is determined based on a similarity measure between neighboring nodes. Within the context of reinforcement learning techniques, scores obtained from a more accurate scoring function can improve the efficiency and accuracy of training a corresponding reinforcement learning model. This way, the system can reduce or avoid inaccurate predictions across different clusters of nodes in the computational graph.

In addition, the described techniques in the specification can improve the efficiency of processing a user query. Performing operations of a trained reinforcement learning model is generally computationally efficient. In contrast to trained policy functions of reinforcement learning models that have a ton of model parameters and/or non-linear operations for predicting actions during inference operations, using a transition matrix to predict inter-nodal transitions along corresponding edges can decrease the computation cost drastically.

In some implementations, the techniques described herein can leverage a Monte Carlo value function to generate trajectories from an initial node to a terminal node, which are relatively shorter than those generated by existing techniques. In this manner, the techniques described herein facilitate provision of data associated with a terminal node in response to a user query by performing fewer computational steps.

Furthermore, the described techniques further enhance the efficiency of training and using a trained model for processing a user query by, as described below in connection with one embodiment, deploying a particular random walk sampling algorithm using implicit user feedback (e.g., user reactions to previously generated output listings corresponding to previous queries). In general, the system described herein can alleviate the cold start problem commonly seen in general sampling techniques by connecting particular listings of items with formative attributes such as shops and tags in a directional computational graph. In addition, the system can further aid in the cold start problem by incorporating implicit user feedback into initial edge weights of the directional computational graph (and eventually an initial probability distribution for random walking sampling from multiple potential edges). In addition, the initial edge weights can be updated during the training process using reinforcement training techniques, and the updated edge weights can be stored in memory offline. The trained random sampling weights are used for generating random walk samplings for processing a user query. This way, the system can train or perform an inference operation using the described techniques for an input user query in a fraction of conventional techniques such as a graphical neural network, and is further scalable and efficient for computational graphs of billions of nodes and tens of billions of edges.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an exchange platform facilitates an exchange of goods, services, or content between providers and users.

FIG. 2 is a block diagram that illustrates an example system for processing a user query.

FIG. 3 illustrates a computational graph representing relations between user queries and listings of items responsive to user queries.

FIG. 4 illustrates two clusters in a computational graph.

FIG. 5 is a flow diagram of an example process for training a reinforcement learning model.

FIG. 6 is a flow diagram of an example process for processing a user query using a trained reinforcement learning model.

FIG. 7 is a flow diagram of an example process for determining a state value function when training a reinforcement learning model.

FIG. 8 is a block diagram of computing devices that may be used to implement the systems and methods described in this document

Like reference numbers and designations in the various drawings indicate like elements.

### DETAILED DESCRIPTION

The described techniques are generally related to processing user queries to provide output predictions (e.g., of product listings) responsive to the user queries on a computing platform, e.g., an exchange platform. In general, an exchange platform is a platform configured to support item exchange and provide information or listings of items in response to user queries. The techniques described herein are also applicable in other applications, including but not limited to, search engine applications, recommendation systems, etc. For brevity and ease of description, the following description is described in the context of exchange platforms.

In an example implementation in the context of an exchange platform, providers may provide items (e.g., goods, services, and content) on an exchange platform that users of the exchange platform (e.g., registered members of the platform or guests of the platform) can obtain. Within a web page provided by the exchange platform, a user can input search queries into a search bar and in response, the exchange platform can identify listings responsive to the query and provide the listings within a first web page listing items matching the search queries. The user may interact with these items, for example, browse these items without further actions, click one or more listings to get more information related to the corresponding items, add one or more items to a shopping cart, or purchase one or more items.

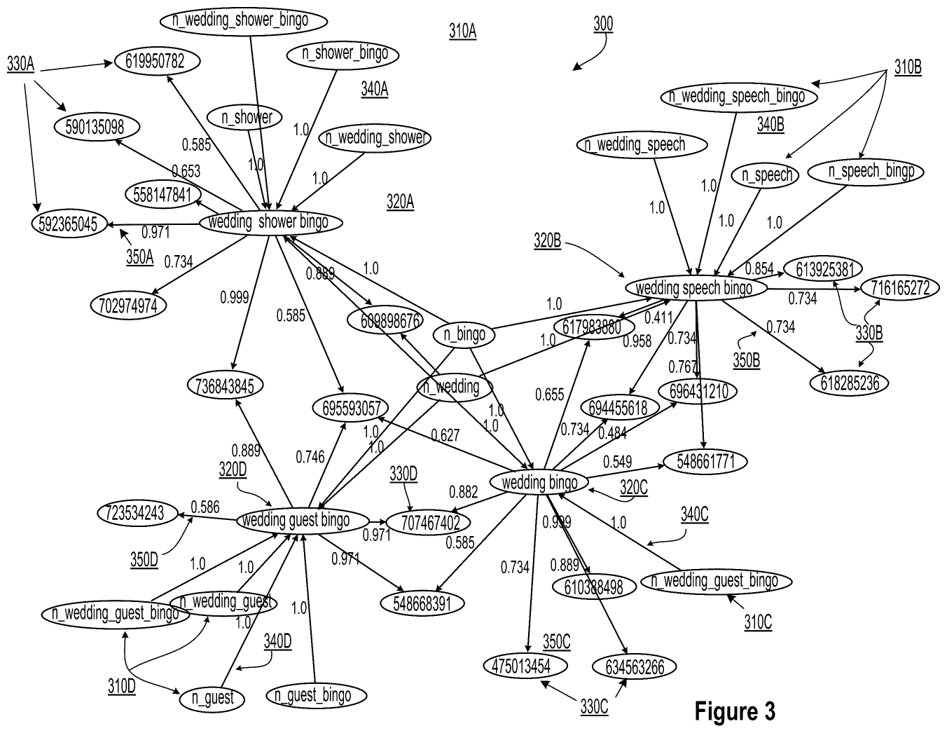

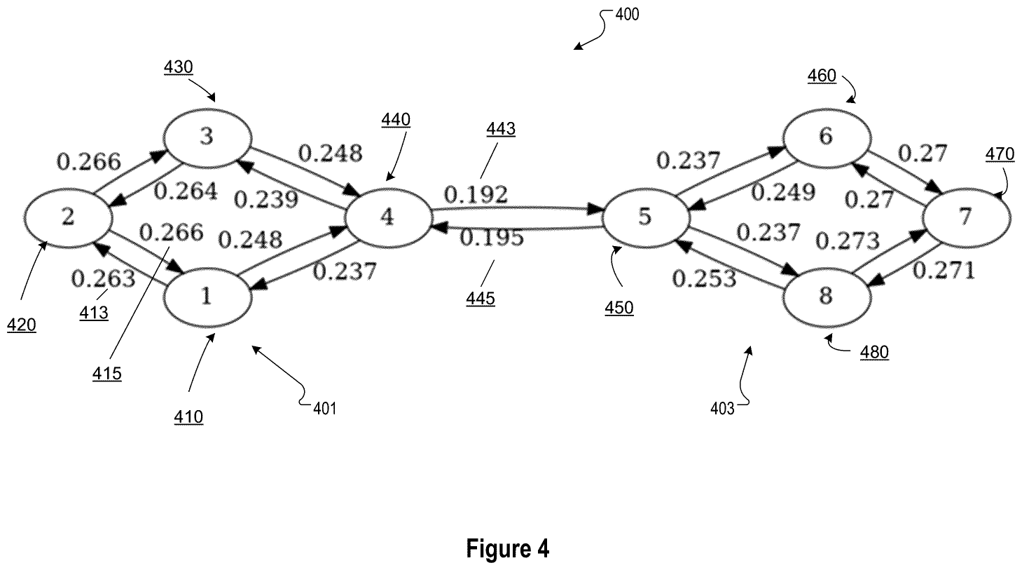

Relations of user queries with listings of items on an exchange platform can be generally represented using a computational graph, and the described techniques can use a computational graph to determine an output (e.g., an item listing) to be provided in response to the user query. The computational graph can be represented as a directional graph or a non-directional graph. A directional graph can include multiple nodes and directional edges connecting corresponding nodes. In such graphs, a user query can be represented by an initial node, and a listing of a particular product as a terminal node. By searching a trajectory including a plurality of connecting directional edges linking nodes starting from an initial node (i.e., a user query) to a terminal node (e.g., a listing of a particular item), the terminal node can be provided as an output in response to processing the initial node. More details of a computational graph are described below in connection with FIGS. 3 and 4.

To search for the trajectory in response to a particular user query, directional edges can be biased using heuristic methods, but such approaches can suffer from multiple drawbacks. First, such approaches often assume unbiased prior probability distribution for directional edges (i.e., the unconditional probability for all directional edges is equal to each other). The unbiased prior probability assumption does not consider contextual or accumulated information for nodes connected by directional edges, information associated with a particular user account that requests the user query, or other statistical data obtained or stored in the exchange platform. Second, such biasing-based approaches also do not implement a mechanism to consider user or system feedback when selecting one of the directional edges, let alone distinguishing users' positive interactions from negative interactions. Third, these approaches also do not optimize or control biasing directional edges across different clusters in the directional graph. In general, each cluster in the directional graph generally includes multiple nodes that are semantically similar to each other, and nodes from different clusters are usually semantically-distant to each other. By not fully considering the dissimilarities across different clusters, a conventional technique might predict an item listing in a cluster different from the one where a corresponding user query belongs, decreasing the accuracy and efficiency for processing user queries.

The techniques described in this document can at least resolve the above-noted limitations. By training and using a reinforcement learning model and considering user feedback information, the described techniques can efficiently process a user query in a computational graph.

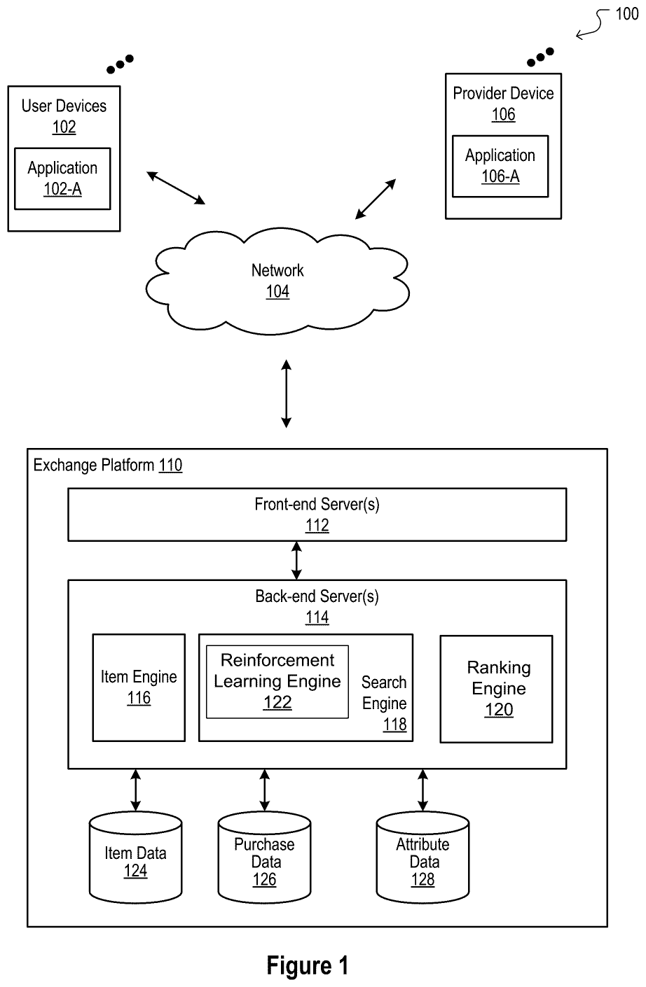

FIG. 1 is a block diagram of an example environment 100 in which an exchange platform 110 facilitates an exchange of items (such as goods, services, or content) between providers and users. The example environment 100 includes a network 104, such as a local area network (LAN), a wide area network (WAN), the Internet, or a combination thereof. The network 104 connects one or more user devices 102, one or more provider devices 106, an exchange platform 110, and one or more external sources 108.

User device 102 and provider device 106 are electronic devices that are capable of requesting and receiving data over the network 104. Examples of such devices include personal computers, mobile communication devices, digital assistant devices, and other devices that can send and receive data over the network 108.

The exchange platform 110 is a computing platform that can be operated and maintained by an exchange service provider. The exchange platform 110 enables providers to list their items on the exchange platform 110 and enables users to obtain the items listed on the exchange platform 110. As depicted in the block diagram of FIG. 1, the exchange platform 110 is depicted as a single block with various sub-blocks. However, while the exchange platform 110 could be a single device or single set of devices, this specification contemplates that the exchange platform 110 could also be a group of devices, or even multiple different systems that communicate with each other to enable the exchange of goods, services, and/or content. The exchange platform 110 could also be a provider of items, i.e., the provider device 106 and the exchange platform 110 can be integrated with each other. Alternatively, the exchange platform 110 can be an entity different from the provider, i.e., the provider device 106 and the exchange platform 110 can be separate, as shown in FIG. 1.

A provider uses an application 106-A executing on a provider device 106 to communicate with the exchange platform 110 to, for example, create or manage listings of items of provider on the exchange platform 110 and/or perform other appropriate tasks related to the exchange platform 110 (e.g., transfer an amount to the provider based on items obtained by users). The application 106-A can transmit data to, and receive data from, the exchange platform 110 over the network 104. The application 106-A can be implemented as a native application developed for a particular platform or a particular device, a web browser that provides a web interface, or another appropriate type of application. The application 106-A can present and detect user interactions (e.g., user's touch, mouse clicks, etc.) with various interfaces that enable, for example, the provider to create and manage listings of the provider's items on the exchange platform 110.

Users of a user device 102 can use an application 102-A to communicate with the exchange platform 110 to, for example, view listings of items, search for items, obtain items, and/or perform other appropriate tasks related to the exchange platform 110. The application 102-A can transmit data to, and receive data from, the exchange platform 110 over the network 104. The application 102-A can be implemented as a native application developed for a particular platform or a particular device, a web browser that provides a web interface, or another appropriate type of application. The application 102-A can present and detect user interactions (e.g., user's touch, mouse clicks, etc.) with various interfaces that enable, for example, the user to view listings of items, search for items, obtain items, and/or perform other appropriate tasks related to the exchange platform 110.

The exchange platform 110 includes one or more front-end servers 112 and one or more back-end servers 114. The front-end servers 112 can transmit data to, and receive data from, user devices 102 and provider devices 106, over the network 104. For example, the front-end servers 112 can provide to, applications 102-A and 106-A executing on user devices 102 and provider devices 106, respectively, interfaces and/or data for presentation with the interfaces. The front-end servers 112 can also receive data specifying user interactions with the interfaces provided by the front-end servers 112 to user devices 102 and provider devices 106. The front-end servers 112 can update the interfaces, provide new interfaces, and/or update the data presented by the interfaces presented in applications 102-A and 106-A, respectively, based on user/provider interactions with user devices 102 and provider devices 106.

The front-end servers 112 can also communicate with the back-end servers 114. For example, the front-end servers 112 can identify data to be processed by the back-end servers 114, e.g., data specifying information necessary to create listings requested by a provider 106, data specifying the quantity of a given item that a user of user device 102 is requesting to obtain. The front-end servers 112 can also receive, from the back-end servers 114, data for a particular user of a user device 102 or data for a particular provider of a provider device 106, and transmit the data to the appropriate user device 102 or provider device 106 over the network 104.

The back-end servers 114 include an item engine 116, a search engine 118, and a ranking engine 120. As used in this specification, the term “engine” refers to hardware, e.g., one or more data processing apparatuses (e.g., one or more processors), which execute a set of programming instructions, that result in performance of a set of tasks. Although FIG. 1 depicts these three engines, the operations of these engines as described in this specification may be performed, wholly or in part, by one or more other engines. In other words, some implementations may include more than the three engines depicted in FIG. 1 to perform the operations described in this specification. Alternatively, some implementations may include fewer engines to perform the operations described in this specification. Further still, even if an implementation includes the same three engines depicted in FIG. 1, the operations performed by one of these engines, as described in this specification, may be performed by one or more of the other engines.

The item engine 116 manages the creation and modification of listings of items, as requested by a provider via application 106-A on a provider device 106. The item engine 116 can receive from the front end-servers 112, data specifying a description of an item for a listing initiated by a provider. Based on this description, the item engine 116 can create the listing within the exchange platform 110. The description of the item can include, for example, a name for the item, a brief description of the item, a quantity of the item, an amount required to obtain the particular item, an amount required to deliver the item to a destination, a fulfillment time for the item to arrive at the destination, and one or more images of the item. The item engine 116 can use some or all of this information to create a listing for the items on the exchange platform 110. The item engine 116 can store the data for the listing, including the received information, in an item data storage device 124. The item data storage device 124 can include one or more databases (or other appropriate data storage structures) stored in one or more non-transitory data storage media (e.g., hard drive(s), flash memory, etc.).

The item engine 116 can also receive from the front end-servers 112, data specifying features of an item listing that a provider 106 may want to modify. For example, provider 106, through application 106-A, may seek to modify one or more features of the provider's item listed on the exchange platform 110. The modified features are communicated from the application 106-A to front-end server 112 over network 104. The item engine 116 in turn receives from the front end-servers 112, data specifying features of the item listing that the provider 106 wants to modify. The features to be modified may include, for example, the quantity of available items and the amount required to obtain the item. The item engine 116 can use the data about the modified features to modify the listing for the items on the exchange platform 110. The item engine 116 can then use the modified features to update the item's features stored in the item data storage device 124.

The search engine 118 manages retrieval of listings of items, as requested by a user via application 102-A on a user device 102. The search engine 118 can receive from the front-end servers 112, data specifying a user's request to search for items, and retrieve items in line with the user's request. If a user searches for an item or a type of item on the exchange platform, the user inputs a search query into a search bar of the application 102-A. The user's search query is received by front-end servers 112, which in turn sends the search query to the search engine 118. The search engine 118 uses the data specified in the search query to identify listing(s) stored in the item data storage device 124. The search engine 118 communicates the identified listing(s) to the front-end servers 112, which in turn provides a particular listing or a summary of listings for presentation on the application 102-A. If a summary of listings is presented to the user in application 102-A, the user can select a link for one listing from among the summary of listings. The user's selection of the link is received by the front-end server 112, which interprets the user's selection as a request for data about the particular listing. The front-end servers 112 request search engine 118 to provide data about the particular listing, which the search engine 118 obtains from the item data storage device 124. The search engine 118 responds to the front-end servers 112 with the obtained data, which is then provided by the front-end servers 112 to the application 102-A in the form of a page showing a listing for the item. The page can be a content page in a native application, or a web page in a web browser.

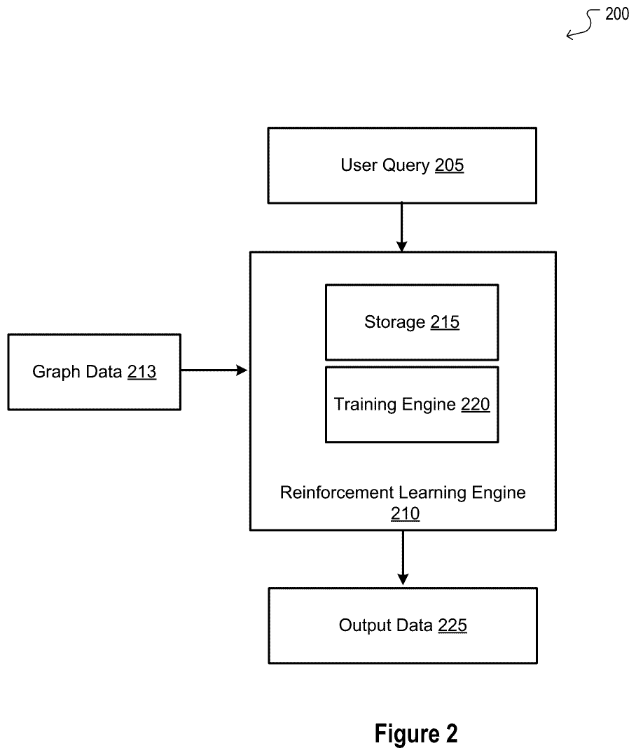

The search engine 118 can further include a reinforcement learning engine 122 configured to process user queries within the context of a computational graph. More details of the process and the reinforcement learning engine 122 are described in connection with FIG. 2.

If a summary of listings, i.e., a plurality of items, is presented to the user in application 102-A, the ranking engine 120 is used to rank the plurality of items in a descending order of relevance to the user. The ranking engine extracts a descriptive set of attributes (such as its color, texture, material, and shape) from each item and learns which attributes the user likes or dislikes, forming an interpretable user preference profile that is used to rank the plurality of items in real-time. An affinity score (e.g., a Beta distribution) is calculated for each attribute. The parameters of the affinity score corresponding to each attribute are stored in the attribute data storage device 128. The attribute data storage device 128 can include one or more databases (or other appropriate data storage structures) stored in one or more non-transitory data storage media (e.g., hard drive(s), flash memory, etc.).

When a user views a listing for an item on the exchange platform displayed on the application 102-A, the user may decide to obtain the item. The user may select a button (or other appropriate user interface element) on the interface presented on application 102-A, which may result in the front-end servers 112 providing a different user interface to the user where the user can enter pertinent details (e.g., quantity of the item, the destination address, payment information) to begin the fulfillment process for obtaining the item. Upon submitting this information (e.g., by clicking a submit button on the user interface), the details entered by the user along with features of the item that the user wants are received by the front-end servers 112 and passed to the item engine 116. The item engine 116 evaluates whether the received data is valid (e.g., whether the quantity of the item requested by the user is the same or less than the available quantity of the item, whether the shipping address is correct, whether the payment information is correct).

If the data received from the user is invalid, the item engine 116 sends a message to the front-end servers indicating that the request is denied, and optionally, may also include a reason explaining why the request was denied (e.g., a payment instrument was not approved or the input shipping address is invalid). The front-end servers 112 can provide a new user interface for presentation in application 102-A, in which the user is notified that the user's request was unsuccessful.

If, however, the data received from the user is valid, the item engine 116 processes the payment using the received payment information and sends a message, including the received user data, to the appropriate provider to begin the fulfillment process. The item engine 116 may store purchase information about the item (e.g., an identifier of the user purchasing the item, the quantity of the item purchased, the amount provided for the item, the date of purchase) in a purchase data storage device 126. The purchase data storage device 126 can include one or more databases (or other appropriate data storage structures) stored in one or more non-transitory data storage media (e.g., hard drive(s), flash memory, etc.). Subsequently, the item engine 116 can send a message to the front-end servers 112, indicating that fulfillment processing has begun. Upon receiving this message from the item engine 116, the front-end servers 112 can provide a new user interface for presentation in application 102-A, in which the user is notified that the user's request was successful and that the order processing has begun.

FIG. 2 is a block diagram that illustrates an example system (e.g., reinforcement learning engine 210) for processing a user query. The reinforcement learning engine 210 can be equivalent to the reinforcement learning engine 122, which is part of the search engine 118 as depicted in FIG. 1.

As shown in FIG. 2, the reinforcement learning engine 210 can process input including one or more user queries 205 and graph data 213 to generate output data 225 in response to the one or more user queries 205.

A user query 205 can be received by the exchange platform (e.g., exchange platform 110 of FIG. 1) from a user device (e.g., device 102 of FIG. 1) corresponding to a user of a user account of the exchange platform 110. The user device can include a smartphone, a smart tablet, or a smart wearable device (e.g., a smart watch), a computer, or other suitable user devices. The user account can be a registered account of the exchange platform or a guest account or identifier attached to a non-registered user of the platform (e.g., without registration). The user query can include a request for data that represents a list of items (e.g., goods, services, and content) on the exchange platform 110 that users of the exchange platform can obtain. The exchange platform can transmit the data corresponding to the user query for representing (e.g., displaying) on a user device.

A user query generally includes information that can be suitably represented by a node in a computational graph. For example, a user query can include a textual portion, a graphical portion, or a combination of the two. The data corresponding to the user query can include a list of items that are semantically related to the user query. For example, the user query can include the text “ring” and be represented as an initial node of a directional graph. The data corresponding to and responsive to the user query can be represented by another node (referred to herein as a terminal node) of the directional graph and including a list of goods such as “wedding rings,” “engagement rings,” “diamond rings,” or other related goods to be displayed on the user device. In some implementations, the user query can further include information such as a user identifier, the user's previous social activities performed on the exchange platform, historical information related to the user's previous purchases, sales, or both, and tags associated with the user account referring to a genre of at least one of preferences, items, services, content, or activities.

Further to the descriptions throughout this document, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Graph data 213 can be generated from historical data representing relations between user queries and corresponding listings of items. Historical data, for instance, can include historical user queries and corresponding listings of items provided to the historical user queries. Historical data can further include user interactions with the provided listings of items, e.g., clicking, adding to carts, purchasing, or indicating a lack of interest. The graph data 213 can be represented as a computational graph. A computational graph generally includes multiple nodes that are interconnected by unidirectional edges. Within the context of the exchange platform and assuming the computational graph being directional, user queries can be grouped into initial nodes, and listing items can be grouped into terminal nodes. Initial nodes in a computational graph do not have any preceding nodes, i.e., an initial node is the starting point of a uni-directional edge. Terminal nodes in the directional graph do not have any succeeding nodes, i.e., a terminal node is the ending point of a directional edge and no further uni-directional edge(s) extend from the terminal node toward other node(s) (other than the node preceding the terminal node).

A computational graph can form trajectories each starting from an initial node and ends at a terminal node. A computational graph can further include intermediate nodes that are positioned along trajectories connecting initial nodes and terminal nodes. The intermediate nodes can include, for example, a shop node(S) representing a shop on the exchange platform, a tag node (T) representing a seller-specific tag or category for a corresponding product, and a user node (U) representing a user associated with the user query. In some cases, a shop node and a user node can be represented by an array of numbers (e.g., “User: 5928” and “Shop: 1529”), and a tag node and a user query node can be represented by a string or a sequence of characters or letters (e.g., “Tag: clothing” and “Query: wedding dress”).

A directional graph further includes multiple directional edges, each uni-directionally connecting two neighboring nodes. More specifically, a directional edge traverses from a first node of a pair of neighboring nodes to a second node of the pair of neighboring nodes. The first node is also referred to as a preceding node with respect to the second node, and the second node is referred to as a succeeding node with respect to the first node. In addition, there can be two opposite directional edges between a pair of neighboring nodes. For example, for two neighboring nodes A and B that are not terminal nodes, a first directional edge can go from node A to node B, and a second direction edge can go from node B to node A. In addition, each directional edge can be associated with a weight or a score indicating a possibility or a reward for transitioning from a first node to a second node along a corresponding directional edge. More details of the computational graph are described in connection with FIG. 3.

The graph data 213 representing the above-described computational graph can be stored in the exchange platform 110, e.g., a memory device of the exchange platform 110. The reinforcement learning engine 210 can receive the graph data 213 from the memory device of the exchange platform 110.

To generate output data 225 for the user query 205, the reinforcement learning engine 210 can predict, using trained model weight values, one or more trajectories for a user query. Each trajectory includes one or more directional edges selected from the computational graph connecting one another and corresponding nodes connected by these directional edges. Each trajectory starts from an initial node and ends at a terminal node. The initial node corresponds to a particular user query, and the terminal node corresponds to a listing of an item that is responsive to the particular user query 205. As described above, the output data 225 corresponding to the user query can include representations (e.g., graphical, textual or both representations, e.g., a listing) of one or more items. A listing of an item can include a product such as a ring, a book, a cellphone, a laptop, or other suitable products.

The reinforcement learning engine 210 can include a training engine 220 to train a reinforcement learning model over training samples. Training samples can include historical data such as historical user queries and historical output data (e.g., one or more listings of items) responsive to the historical user queries. In some cases, training samples can also include user feedback information. For example, user feedback information can include user interactions with the historical output data responsive to historical user queries. User feedback can include positive feedback or interactions such as clicking, adding to cart, or purchasing a listing of an item, and negative feedback or interactions such as indicating a lack of interest in the listing of an item. The training engine 220 can update model weight values for the reinforcement learning model by optimizing an objective function. In the context of a reinforcement learning model, an objective function can include a total reward (e.g., a value function for a state, also referred to as a state value function) in each episode (e.g., one or more time steps). The reinforcement learning engine 210 can store the trained reinforcement learning model in the storage 215, and deploy the trained model to process user queries 105 and graph data 213 for generating an output data 225. In some implementations, the reinforcement learning engine 210 can store a converged state value function or a policy function (e.g., a transition matrix) of a trained reinforcement learning model in the storage 215, and use the converged state value function or policy function to process user queries for generating output data 225.

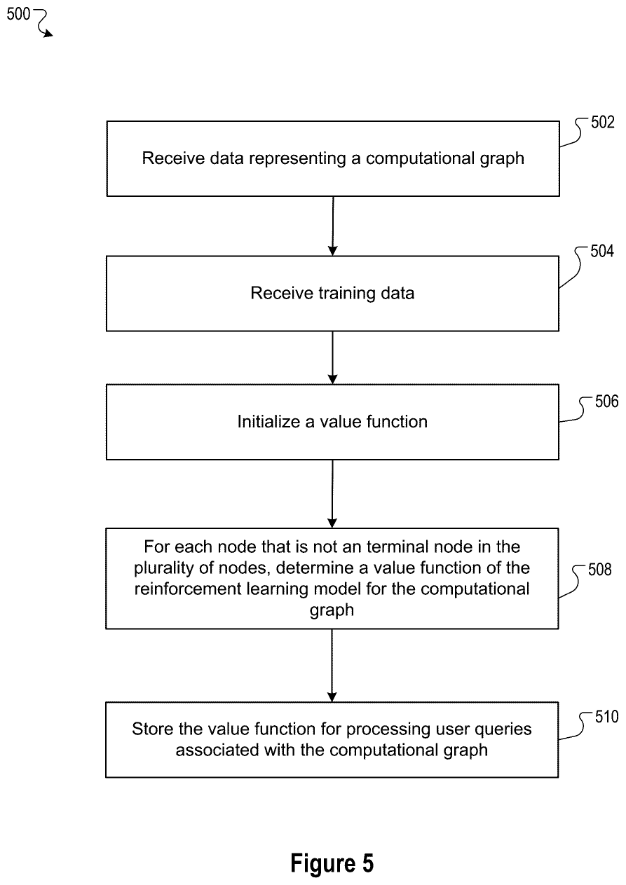

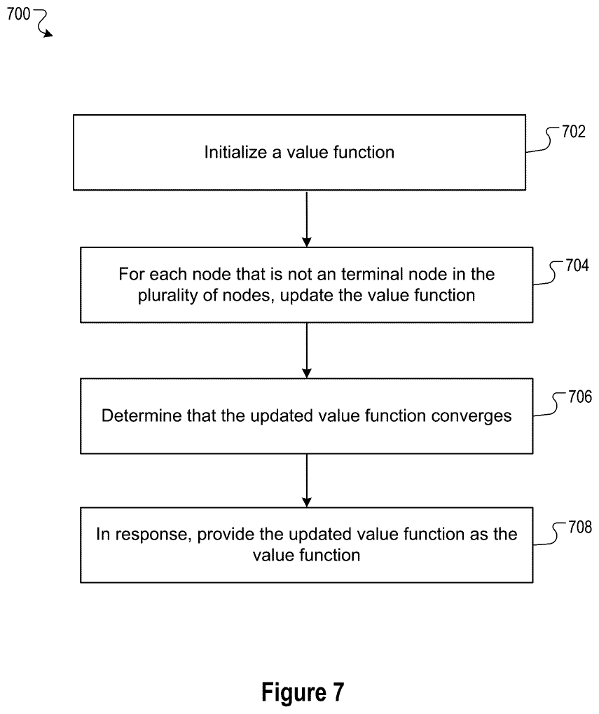

Rather than using heuristically determined weights for biasing the directional edges to process user queries, the reinforcement learning engine 210 can use user feedback information “implicitly” (e.g., occurrences of different types of user interactions) to generate initial weights assigned to corresponding directional edges, and update the initial weights via training a particular reinforcement learning model. The user feedback information represents both positive and negative user feedback in historical data, thus the initial weights can be more accurate than those generated without such user feedback, further improving the training efficiency and reducing the training cost. A positive user feedback can include, for example, clicking, adding to a cart, or purchasing a listing of an item in response to a previous user query, and a negative user feedback can include, for example, scrolling pass or closing a user interface displaying a listing of an item provided in response to a user query. In general, the initial weights determined for directional edges connecting nodes with more accumulated positive reactions generally have higher values than other directional edges. These higher-weight-value directional edges are namely “biased” over the other directional edges. In addition, the initial weights can also be used for sampling random walks (e.g., a policy for moving from a node to another via a directional edge) for training and using reinforcement learning models. Details of the random walk sampling techniques used in the reinforcement learning models are described below in connection with FIG. 7. In addition, two different reinforcement learning models, and their corresponding training and inference operations are described in greater detail in connection with FIGS. 5-7.

FIG. 3 illustrates a computational graph 300 representing relations between user queries and listings of items responsive to user queries.

In general, the exchange platform (e.g., exchange platform 110 of FIG. 1) can include historical data representing relations or interactions between user queries and corresponding output data for user queries. For example, the historical data can include a previous user query related to “wedding,” “wedding shower,” “wedding speech,” or “wedding guest,” and corresponding output data responsive to the previous user query. For example, the output data represents a listing of an item related to a “wedding,” “wedding shower,” “wedding speech,” or “wedding guest.” These listings of items are associated with items offered by providers on the exchange platform. The relations and interactions between user queries and corresponding output data can be used to generate a computational graph (e.g., a computational graph 300 of FIG. 3).

As shown in FIG. 3, the computational graph 300 can include one or more initial nodes (Q) representing user queries. The initial nodes can include a first user query 320A related to a “wedding shower,” a second user query 320B related to a “wedding speech,” a third user query 320C related to a “wedding,” and a fourth user query 320D related to a “wedding guest.”

The computational graph 300 can include one or more terminal nodes (L) representing output data (e.g., one or more listings of items) for corresponding user queries. In some cases, for exchange platforms having listing inventory from providers running shops or stores on the exchange platform, listings of items can be further grouped by shops or stores they belong to, and each listing can be further tagged by providers with different tags for better describing the item. Given that, terminal nodes (L) can be further partitioned into shop nodes(S) and tag nodes (T). A shop node(S) generally represents a unique shop identifier for the corresponding shop, and a tag node (T) generally represents a respective tag for the item listing. For example and as shown in FIG. 3, the initial node 320A is linked to one or more shop nodes 330A, each shop node having a unique identifier, e.g., represented by a sequence of numbers. The initial node 320A is also linked to one or more tag nodes 310A each tag node having a respective tag, such as a “n_wedding_shower_bingo,” “n_shower_bingo,” “n_wedding_shower.” It should be appreciated that tags for different listings of items do not have to be unique as long as the tags can provide additional searchable metadata. In some cases, two or more listings of items can share a common tag. For example, the system (or a seller or shop owner of the exchange platform) can associate a listing that represents an article of clothing with a tag (e.g., “tag: clothing”). Based on this tag and other tags, the system can generate a directional computational graph with multiple nodes such that a node corresponding to the “tag: clothing” has one or more departing edges pointing toward all listing nodes associated with the “tag: clothing.”

Each terminal node (L), (S), or (T) is connected with an initial node (Q) by a respective edge in the computational graph 300, and each respective edge has a weight value associated with it. An edge can have one or two directions, and each direction can have a respective weight value. More specifically, weight values for two opposite directional edges between two neighboring nodes can be different. For example, a directional edge from node A to node B can be determined with a weight value of 0.2, and another direction edge from node B to node A can be determined with a weight value of 1.4. Note these weight values are provided as examples and should not be used to infer a range or a scale for the weight values. In some cases, weight values can be normalized such that the range of a weight value goes from zero to one.

A weight value can represent a likelihood or an instant reward of transitioning between nodes along the direction. The weight value or edge weights can be determined using different techniques, for example, heuristic techniques, incorporating user feedback information, reinforcement learning, or other suitable techniques. The process of determining weight values are described below in connection with FIG. 7.

As shown in FIG. 3, a first edge 350A from node 320A to one of the shop nodes 330A (e.g., “592365045”) can have a weight value of 0.971, and a second edge 340A from node 320A to one of the tag nodes 310A (e.g., “n_shower_bingo”) can have a weight value of 1.

Similarly, other user query nodes (e.g., nodes 320B, 320C, and 320D) can be connected with their respective shop nodes (e.g., nodes 330B, 330C, and 330D) and tag nodes (e.g., nodes 310B, 310C, and 310D) using respective edges (340B, 340C, 340D, 350B, 350C, and 350D) with respective weight values.

In addition, a computational graph can have one or more different clusters, each cluster can have one or more user query nodes and corresponding listing nodes (shop nodes and tag nodes). In general, since different clusters can represent different semantic information determined from different user queries, user queries in different clusters normally have less similarities than those in the same cluster. The described techniques can apply a particular algorithm to “bias” the edge weight values to reduce the likelihood of transitions across different clusters. More details of determining weight values are described below in connection with FIG. 7.

FIG. 4 illustrates two clusters 430 and 460 in a computational graph 400. As an example, a computational graph 400 includes a first cluster 401 and a second cluster 403. Although two clusters 401 and 403 share different characteristics, in some situations where soft boundaries are applied, a node 440 or 450 or both can be assigned into two clusters 401 and 403. Accordingly, the two clusters 401 and 403 can be connected with each other by two directional edges 443 and 445 connecting the two nodes 440 and 450. The first cluster 401 can include multiple nodes, e.g., nodes 410, 420, 430, and 440, and one or more of these nodes in the first cluster 401 can be a query node(s), and the rest of the nodes can be a listing, shop, or tag node(s). Similarly, the second cluster 403 can also include multiple nodes, e.g., nodes 450, 460, 470, and 480, and one or more of these nodes in the second cluster 403 can be a query node(s), and the rest of the nodes can be a listing, shop, or tag node(s). Nodes in the same cluster are connected with one another by directional edges associated with weight values. A weight value generally refers to a likelihood or a reward of transitioning from a first node to a second node along an edge, as described above. Also, to efficiently and accurately determine listing nodes for user queries, weight values assigned to edges connecting nodes in the same cluster should be “biased” by algorithms such that edges connecting nodes in the same cluster can have greater weight values than those connecting nodes across different clusters. For example and as shown in FIG. 4, the weight values for edges 443 and 445 connecting nodes 440 and 450 from two clusters have weight values less than 0.2, while other edges (e.g., edges 413 and 415) connecting nodes in the same cluster (e.g., nodes 410 and 420) have weight values at least greater than 0.23. Weight values for edges are determined through training a reinforcement learning model, and in some cases, the exchange platform can determine and assign initial weight values for different edges based on user feedback information from stored historical data. More details of determining weight values are described in connection with FIG. 7.

FIG. 5 is a flow diagram of an example process 500 for training a reinforcement learning model. For convenience, the process 500 is described as being performed by a system of one or more computers located in one or more locations. For example, a system, e.g., the exchange platform 110 of FIG. 1, the search engine 118 of FIG. 1, or the reinforcement learning engine 122 of FIG. 1, when appropriately programmed, can perform the process 500.

To train the reinforcement learning model, a system implementing the described techniques first receives data representing a computational graph (502). A computational graph can include a directional graph with multiple nodes and directional edges, as described above. Each directional edge of the multiple directional edges connects two neighboring nodes in the multiple nodes. The directional edge starts from a preceding node of the two neighboring nodes and ends at a succeeding node of the two neighboring nodes. The multiple nodes include one or more initial nodes, each initial node corresponding to a user query, and one or more terminal nodes, each terminal node associated with data corresponding to a respective user query. In general, initial nodes do not have any preceding nodes connected by directional edges. Similarly, terminal nodes do not have any succeeding nodes connected by directional edges. However, in some cases, nodes are referred to as initial nodes if they are chosen as start nodes for random walk sampling. Similarly, nodes are referred to as terminal nodes if they happen to be the end nodes where the random walk stops. In this context, the initial nodes and terminal nodes can have both inbound and outbound edges.

As an example, the described techniques can construct a weighted bipartite graph G=(Q, L, E, W) where Q represents query nodes (or initial nodes), L represent listing nodes (or terminal nodes), E represents edges connecting different nodes, e.g., E={e_{i,j}=(qᵢ, lⱼ)|qᵢ E Q & lⱼ∈L}, and W represents weight values for respective edges E.

In some cases, the system can extend a computational graph to include additional types of nodes for enhanced connectivity, which in turn can improve the efficiency and accuracy of processing user queries. For example, the system can extend the above-noted weighted bipartite graph G by including shop nodes(S) and tag nodes (T) into the graph G. This way, the system can generate an extended connectivity for historical query nodes and listing nodes. In addition, the extended graph remains bipartite: {Q, S, T}, which is a separate partition from the listing nodes L. Accordingly, the above-described extension technique does not render the extended graph incompatible with a reinforcement learning framework designated to the original weighted bipartite graph G. Rather, algorithms and techniques applied to the original bipartite graph remain applicable to the extended bipartite graph. In some cases, the weight values of edges between shop or tag nodes and listing nodes can be set as 1, e.g., w_{q}_{ᵢ}_{,sj}=w_{q}_{ᵢ}_{,tj}=1.

The system receives training data for training the reinforcement learning model (504). The training data can include multiple training examples. For example, the training data can include multiple query-list pairs. Each query-list pair includes a particular user query received by the system and a corresponding list of ground-truth items corresponding to and responsive to the received user query. The ground-truth items can be labeled automatically using pre-processing models or manually labeled. In some implementations, the query-list pairs can include historical data where each query-list pair in the historical data includes a user query and a corresponding listing provided to the user query that has achieved a threshold effect. For example, the provided listing of an item has achieved a threshold percentage of conversation rate, e.g., 80% of user accounts requesting the user query have positive interactions with the provided listing. The positive interactions, as described above, can include clicking or tapping on representations of the listing, completing a transaction with the listing, saving the listing on a user device for later, or other suitable positive interactions.

In general, historical data can implicitly carry user feedback information. Such feedback information can include positive user feedback and negative user feedback. Positive feedback can include, e.g., a user clicking a listing of item, adding the listing of an item into a shopping cart, or purchasing the listing of item, when provided with a listing of an item responsive to a particular user query. Negative feedback can include a user scrolling past a listing of an item displayed on a user interface, closing the user interface, indicating lack of interest to the representations, turning off the display, or other suitable negative feedback. The historical data, for example, can be stored as a particular data structure (e.g., a query log) in the memory storage.

The described framework for training and using a reinforcement learning model to process user queries within a computational graph setting considers implicit user feedback information. More specifically, given a query log which records for each query qᵢ, the set of listings, Lᵢ^{click}, Lᵢ^{cart}, Lᵢ^{purchase}, respectively representing listing nodes (or terminal nodes) provided responsive to the query that the user clicked on, added to the shopping cart, and purchased. Note that the above-described types of user feedback information are listed as examples to assist the description of corresponding algorithms described below, and other suitable categorizations for classifying or defining implicit user feedback information can be used.

To generate the bipartite graph G from historical data, the system adds each unique user query in a query log \hat{q}ₗ, and add the query log \hat{q}ₗ into the group of query nodes. Each query can be uniquely identified using an identifier (e.g., a text string). The system adds each unique listing in the listing log [symbol] , and adds the listing log [symbol] , into the group of listing nodes. The system collates the query log and listing log by generating a set of query-listing pairs ( [symbol] , [symbol] )), and counts the number of occurrences of clicks, adding to cart, and purchases for each query-listing pair. For each query-listing pair ( [symbol] , [symbol] ), the system adds, into the edge set E, an edge e_{i,j} connecting two nodes in the pair, and associate the edge with a respective weight value w_{i,j} to the edge. The weight value w_{i,j} is added to the weight set W. In general, a higher weight value relates to a higher likelihood that a user would be interested in a listing node provided responsive to a particular user query.

The weight value w_{i,j} between two nodes i and j can be calculated based on the implicit user feedback information. For example, the weight value w_{i,j} can be a weighted sum based on the total occurrences of clicks, adding to cart, and purchases for a query-listing pair ( [symbol] , [symbol] ). One example equation for determining the weight value w_{i,j} is as follows:

$${w}_{i , j} = {C}_{1} \vert {click}_{i , j} \vert + {C}_{2} \vert {cart}_{i , j} \vert + {C}_{3} \vert {purchases}_{i , j} \vert . \qquad Equation ( 1 )$$

In Equation (1), coefficients C₁, C₂, and C₃ are predetermined weights for different user interactions. To bias listings with more purchases than clicks or carts, the system can generally have any suitable values that satisfy C₁<C₂<C₃.

In some cases, the above-noted weight values w_{i,j} obtained from historical data can be used as initial values for edges in the computational graph. These weight values can be updated by training various reinforcement learning models over training data.

The system can generate training data based on historical data or receive historical data as training samples to train a reinforcement learning model. For example, the system can gather historical data for a previous time period, e.g., a month, a year, or other suitable time period. The historical data can include records of user queries and item listings that were clicked, added to cart, or purchased by users. The user queries are represented by query text, and the listings are represented by unique IDs (e.g., shop IDs) and title of items (e.g., tags) that belong to the unique IDs. For example, the record can include over 100 millions unique listings, over 100 millions unique user queries, 60 millions tags, and 3 millions unique shop IDs. The record can further include over 1 billion query-listing interactions, where 3.4% percent of purchases, 6.2% percent car adds, and 90.2% clicks. The corresponding computational graph representing the historical data and record can include over 1 billion edges.

Before training a reinforcement learning model, the system further obtains data that defines a reward function. A reward function r(s,a) is generally a function that receives (i) a current state of an agent in an environment (i.e., s in the reward function), and (ii) an action determined by a policy (i.e., a in the reward function) to be performed by the agent in the environment, and generates a reward for the agent performing the determined action at the current state. The reward function can be particularly designed based on different requirements for training the reinforcement learning model. For example, in the context of a directional graph, a current node in the directional graph is considered a current state, and a directional edge among multiple directional edges from the current node is considered an action. The system can select an action to perform by selecting one of the directional edges from the current node to traverse in the directional graph. The system obtains a reward based on the reward function when taking the selected edge at the current node, and the system reaches a next state at a succeeding node after traversing along the selected directional edge.

The system also initializes a value function of the reinforcement learning model (506). The value function can include an action value function Q(s,a) that receives (i) a current state s of an agent and (ii) an action a generated by a policy and to be performed by the agent and determines an expected return after the agent takes the action at the current state. In other words, the action value function is configured to generate a respective value for each pair of a current node and a respective directional edge starting from the current node. In some implementations, the value function can include a state-value function V(s) that receives a current state of the agent to determine an expected return after the agent takes actions following a policy. In general, the system can initialize the state value function and/or the action value function to be zero.

The expected return can include an expectation of weighted rewards for each state in a sequence of states after the current state. For example, in the context of a directional graph, a sequence of states can include a sequence of nodes following the current node and connected by corresponding directional edges that form a trajectory. The trajectory ends at a terminal node in the directional graph. The expected return can include a weighted sum of (i) an immediate reward for the node taking a selected directional edge and (ii) a discounted reward for rewards obtained at succeeding nodes by selecting respective directional edges (e.g., a state value for a node that immediately succeeds the current node). The discounted reward is generated using a discount factor that can be specifically designed according to different training requirements. For simplicity, the value function in the description below refers to the state value function by default. One example of initializing a value function is described below in connection with FIG. 7.

Referring back to training a reinforcement learning model, after receiving the computational graph, the system determines, for each node that is not a terminal node in the plurality of nodes, a value function of the reinforcement learning model for the computational graph (508). More specifically, to train the reinforcement learning model, the system generally tries to maximize the action value function Q(s,a) for all states repeatedly until the value function V(s) converges. The system can generate a transition function based on the action value function Q(s,a). Within the framework of computational graphs, the states refer to different nodes (e.g., user query nodes) and the actions refer to different edges connecting two neighboring nodes. Each edge can be assigned with a weight value that can relate to an instant reward or an action value for transitioning along the edge at the node. As described above, each edge in the computational graph can be assigned with a respective initial weight value determined from historical data. The initial weight values can represent an initial likelihood for transitioning along corresponding edges from respective nodes. Details of determining the value function when training a reinforcement learning model are described in connection with FIG. 7.

Once the value function is determined, the system stores the value function for processing user queries that are associated with the computational graph (510). In some cases, the system generates a policy model (e.g., a transition function from a node to another node along an edge from the node) from the determined value function (or the action value function). The system can store the policy function in the memory unit of the exchange platform. The stored value function or policy function can be used at a later time for processing user queries associated with the computational graph.

In some implementations, the system can store the value function in a memory device of the system. The system can provide the stored value function as an offline reinforcement learning model for processing a user query at a later time. In addition, the training process of the reinforcement learning model can be performed offline, and the determined value function or policy function can be deployed for processing user queries online.

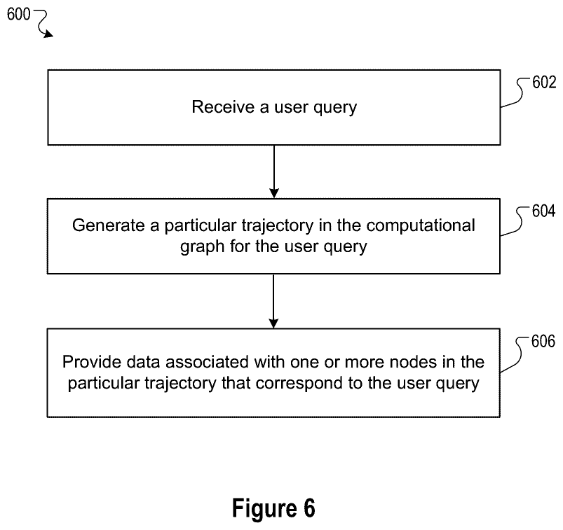

FIG. 6 is a flow diagram of an example process 600 for processing a user query using a trained reinforcement learning model. For convenience, the process 600 is described as being performed by a system of one or more computers located in one or more locations. For example, a system, e.g., the exchange platform 110 of FIG. 1, the search engine 118 of FIG. 1, or the reinforcement learning engine 122 of FIG. 1, when appropriately programmed, can perform the process 600.

To process a user query, the system performs inference operations of the trained reinforcement learning model. For example, the system can fetch data representing the determined value function or policy function from memory, and process a user query using the computational graph based on the determined value function or policy function.

The system receives a user query (602) from a user device. The user query corresponds to an initial node of multiple initial nodes in the directional graph stored in the exchange platform. A user query can include text information, graphic information, or other suitable information indicating a corresponding user's interest. The system can set the user query as an initial node in the computational graph. In some cases, the system can select an existing user query node as the node for the user query. Alternatively, the system can generate a new user query node for the user query after determining a location for the new query node. To determine the location, the system can generate embeddings of the information included in the user query, and determine the location based on the embeddings. Once the new user query node is added to the computational graph, the system can determine a connectivity of the user query node to other existing nodes using various techniques. For example, the system can connect the new user query node with all possible existing nodes or nodes in a cluster that encompasses the location of the new user query node. (Alternatively, the system can determine a level of similarity between the user query to existing user query nodes, and determine the location based on the level of similarity. And if a new query and an existing user query node shares a level of similarity above a threshold level, the system can assign the new query to the existing user query node.

After receiving the user query, the system generates a particular trajectory in the computational graph using the value function (or policy function) of the trained reinforcement learning model (604). The particular trajectory includes multiple nodes and multiple edges connecting these multiple nodes. The particular trajectory starts from the user query and ends at a terminal node in the computational graph. For example, the system can generate transitions identifying edges between neighboring nodes based on the value function (or policy function). In some cases, the value function can specify multiple candidate trajectories starting from the new user query node, each candidate trajectory having a respective accumulated reward. The system can determine the trajectory by selecting one of the multiple candidate trajectories as the trajectory based on the accumulated rewards. For example, the system can select one having the maximum accumulated reward among all candidate trajectories. In some cases, the system can select more than one trajectories for a single user query.

In some cases, the system can determine a trajectory at a node level. For example, the system selects, for a first node, one edge from multiple edges at the first node for a first step, and transitions to a second node from the first node using the selected edge. The system then selects, for the second node, another edge from multiple edges at the second node for a second step, and transitions to a third node from the second node using the selected other edge. The system can repeatedly select edges and transition from nodes using selected edges until reaching a terminal node. At each step, the system can select an edge for a node from a global point of view. For example, the system can determine a value function for the node and select the edge that maximizes the value function. Alternatively, or additionally, in some cases, the system can select edges based on local, instant rewards (e.g., r(s,a) of a reinforcement learning model). For example, the system can determine instant rewards r(s,a) for transitioning from different edges at a node, and select an edge that has the maximum instant reward.

In some situations, the trajectory length (i.e., the number of nodes and directional edges included in a trajectory) can be determined using different methods. In some implementations, the trajectory length can be preset based on a number of directional edges. For example, a system can preset the number of directional edges as 2, 3, 5, 10, or more for generating multiple directional edges. In cases where the random walk algorithm is used, the system can perform a number of random walks with the preset trajectory length. For situations where terminal nodes are unknown to the system, the trajectory length is not prefixed but dynamically determined after a terminal node is reached. The trajectory length can be determined in real time by counting the number of edges starting from an initial node to the terminal node.

The system provides data associated with trajectory in response to the user query to the user device (606). For example, the system can provide data associated with the terminal node in the trajectory to the user device. The terminal node can include a listing of an item, or information related to a shop and a tag of items belonging to the shop. In some cases, the system can provide data associated with additional nodes in the trajectory to the user device. For situations where the system selects more than one trajectories, the system can provide multiple terminal nodes from these trajectories to the user device. Upon receiving the data, the user device can display the data (e.g., one or more listings of items) on a display.

FIG. 7 is a flow diagram of an example process 700 for determining a value function when training a reinforcement learning model. For convenience, the process 700 is described as being performed by a system of one or more computers located in one or more locations. For example, a system, e.g., the exchange platform 110 of FIG. 1, the search engine 118 of FIG. 1, or the reinforcement learning engine 122 of FIG. 1, when appropriately programmed, can perform the process 700.

The techniques described in this specification implement two different reinforcement learning models: a value iteration method and a Monte Carlo value function estimation method, for processing user queries in the exchange platform. Accordingly, the two different reinforcement learning models are described immediately below before getting into the details of the process 700 for determining a value function when training a machine learning model.

The value iteration method generally optimizes an objective function (e.g., a reward function) by iteratively updating an action value function for all possible actions at each state, and iteratively updating a state value function for the state based on the updated action value function. The system determines the value function after determining that the state-value function converges.

The Monte Carlo value function method, on the other hand, generally optimizes an objective function using random walks. The system samples a random walk (e.g., a randomly selected directional edge based on a probability distribution) for a current state (e.g., a current node) and scores the random walk using a scoring function. The Monte Carlo value function method can, based on the scoring function, define contextual information based on historical interactions for nodes in the directional graph. For example, the historical interactions can include previous positive interactions associated with terminal nodes for a user query. The historical interactions implicitly include user feedback information, which can be fused into the random walk sampling techniques implemented with the Monte Carlo value function method. The scores for random walks along a trajectory that terminates at a terminal node having previous positive interactions are “biased” (i.e., having higher scores) than other random walks for the user query. A score is generally related to a reward associated with a sampled random walk, and ultimately related to a weight value associated with a corresponding edge in the computational graph.

To determine the value function when training the reinforcement learning model, the system first initializes values for the value function (702). In some cases, the system can initialize the value function with predetermined values, values determined using a probability distribution (uniform, Gaussian, or other suitable distributions), or values determined using historical data.

For situations where Monte Carlo value function method is implemented, the system can initialize the value function according to initial edge weight values. As described above, the initial edge weight values w_{i,j} can be determined based on a weighted sum of occurrences user interactions with output listings in response to user queries. The user interactions can include clicking, adding to the cart, and purchasing the output listings.

After initializing the value function, the system updates, for each state of an episode (e.g., an entire sequence from an initial node to a terminal node), the corresponding action value function based on (i) a respective directional edge that starts from the node and connects a succeeding node and (ii) a value associated with the reward function. The respective directional edges include all possible directional edges starting from the node. The value associated with the reward function can be, for example, an instant reward for taking a respective directional edge at the state, or, as another example, the values associated with the reward function can be a state value for the state, e.g., an expected return from the current state.

For the value iteration method, the system first updates the value function (i.e., the action value function) by updating, for each node and each possible directional edge that starts from the node, an expectation of return value of an action value function. The return value is a weighted sum of (i) an immediate reward after taking a particular directional edge at the node and (ii) a state value obtained for a respective succeeding node connected in the particular directional edge. The state value is generated by a state value function and can be discounted by multiplying the state value by a discount factor. The discount factor can be a suitable positive real number that is less than one. To update the value function, the system first generates an intermediate value by summing the immediate reward and the discounted state value, and generates a weighted sum of all intermediate values for all possible directional edges from the current node. The weights for summing intermediate values related to a probability distribution that indicates a likelihood of a current state transitioning into a next node along the particular directional edge. After updating the action value function using all possible directional edges for the state, the system updates the state value function based on the updated value function.

For the Monte Carlo value function method, the system determines multiple candidate random walks for each node in the direction graph. The system further determines the walk length (e.g., a number of edges in the computational graph or a trajectory length described above) for each of the multiple candidate random walks. For example, the multiple candidate random walks can include one thousand to one million random walks, and the walk length for each of these candidate random walks can include three steps, each step corresponding to an edge in the computational graph. In each step of a candidate random walk, a corresponding node transitions to a respective succeeding node along a different directional edge in the directional graph.

The system samples a random walk from the K candidate random walks based on a probability distribution. The probability distribution indicates a likelihood of transition from a node to a succeeding node along a corresponding edge for each random walk. The probability distribution is determined based on the value function for the current node. The sampled random walk in the directional graph context is equivalent to the selected directional edge starting from the current node. One example random walk sampling technique is based on the Metropolis-Hastings algorithms using implicit user feedback information. More details of the example random walk sampling technique are described below.

The system scores the sampled random walking using a scoring function of the reinforcement learning model. The scoring function can be particularly designed for satisfying different training requirements. For example, the system can determine or obtain data representing occurrences of visits to nodes that are traversed for processing user queries (e.g., a number of visits to terminal nodes responsive to user queries) in the historical data, and determine a score for a sampled walk based on the node it walks to and the occurrences of visits associated with the node. In some cases, the scoring function can be determined based on a measure of similarity between the node and the succeeding node associated with the sampled random walk along the directional edge. For example, the scoring function can be a nonlinear function of the measured similarity, e.g., a power function.

In the Monte Carlo value function method, the system updates, for each state (e.g., a node) in an observed random walk, the action value function by a weighted sum of a state value function for the state and the score determined for the random walk. The weights sum to one and range from zero to one. The system further updates the score by multiplying a learning factor. The learning faction can range from zero to one, including 0.1, 0.3, 0.5, or other suitable values. The Monte Carlo value function method is related to every-visit Monte Carlo algorithm.

For both reinforcement learning algorithms, the system determines whether a state value function for a current state converges after repeatedly updating the value function for all nodes in the directional graph. As described above, the state value function can be determined by taking the maximum value from an action value function for the current state.

In response to determining that the state value function converges, the system provides the updated value function as the value function. The system can process a user query using the stored value function in the inference stage, as described above.

Referring to the Monte Carlo value function method, the system can implement different techniques to sample random walks. One advantageous approach is to consider implicit user feedback information in the sampling algorithm for better efficiency and accuracy. One example of random walks sampling techniques can determine a probability distribution indicating a likelihood of transitioning along a particular edge using implicit user feedback information. As described above, the system can determine initial weight values w_{i,j} for edges in the computational graph.

The initial edge weight values can be determined using a cumulative distribution function. One example cumulative distribution function for each node n and assorted edge E_{n,*} in the decreasing order of corresponding weights W_{n,*} such that W_{n,*}>W_{n+1,*} is presented as below:

$${CDF}_{n , i} = \frac{{\sum }_{j = 0}^{i} {w}_{n , j}}{{\sum }_{k = 0}^{\vert {E}_{n , *} \vert} {w}_{n , k}} \qquad Equation ( 2 )$$

To reduce the computational cost for sampling, the system implements Metropolis-Hastings algorithm to improve the Inverse Transform Sampling. The Metropolis-Hastings algorithm is a Markov chain Monte Carlo method for obtaining a sequence of random samples from a probability distribution from which direct sampling is difficult. The system can further sample edge transitions based on a conditional probability P (Eₙ_{ᵢ}_{,*})=wₙ_{ᵢ}_{,j}−wₙ_{ᵢ}_{,j-1}.

In addition, as a faster approach, the system implements a breadth first search (BFS) algorithm instead of a depth first search (DFS) algorithm for sampling random walks. Although the BFS algorithm needs slightly more memory, the BFS algorithm has better cache coherence than the DFS algorithm because it has few cache misses. One example sampling algorithm is described below.

The example algorithm receives as input a starting node n, a predetermined number of walks c, a predetermined walk length k, a set of edges E, weight values W in a computational graph determined based on historical data, and a multiplier m. The example algorithm further receives global variables such as a variance, a dictionary of nodes, and a set of count values.

The system implementing the example algorithm first selects an i^{th} node of a sequence of nodes sorted in a predetermined order. To achieve it, the system selects a particular edge E_{n,*} from the edge set E according to a uniform distribution, and search for the node using binary search.

For each walk of the total number of walks, the system performs the Metropolis-Hastings algorithm to sample a j^{th} node of the sequence of nodes sorted in a predetermined order based on the i^{th} node and the global variance. The edge connecting the i^{th} node to the j^{th} node is the edge selected for the random walk. The system then performs the Metropolis-Hastings algorithm on the j^{th} node repeatedly. In addition, the system can recursively perform the algorithm for the same node sampled with different edges. This way, the system can efficiently sample random walks and store all possible trajectories starting from the i^{th} node in a data structure. In some implementations, the system can rearrange the stored random walks according to a predetermined order, e.g., a non-increasing order.

For Monte Carlo value function method implementing Metropolis-Hastings algorithm, the system repeatedly updates the weight values w_{i,j} when training the reinforcement learning model. The updated weight values in turn updates the probability distribution for sampling random walks using the Metropolis-Hastings algorithm.

Once the reinforcement learning model is trained using the Monte Carlo value function method, the system can process a user query by generating a random walk on the query node using the trained Metropolis-Hastings algorithm, and score the random walk using a particular scoring algorithm. Since the trained random walk sampling algorithm implicitly reflects the value function of the Monte Carlo Value function, the system can process a user query using random walks. More specifically, the system samples random walks using the above-described algorithm to predict a trajectory that traverses from an initial node corresponding to the user query to a terminal node associated with data corresponding to the user query.

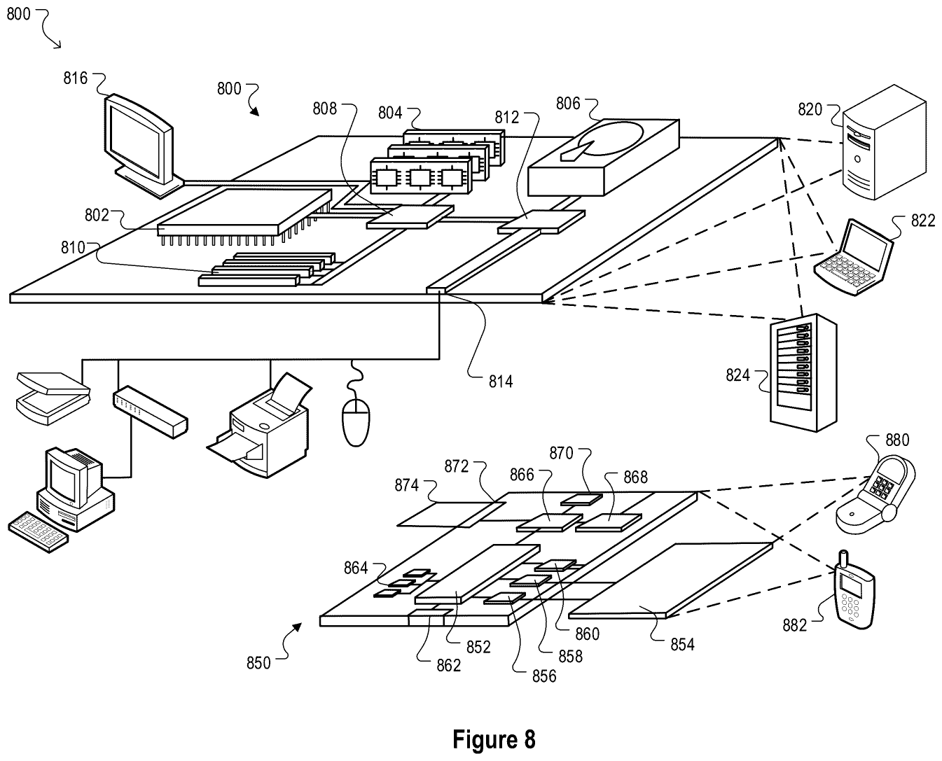

FIG. 8 is a block diagram of computing devices 800, 850 that may be used to implement the systems and methods described in this document, either as a client or as a server or plurality of servers, or in cloud computing environments. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 800 includes a processor 802, memory 804, a storage device 806, a high-speed interface 808 connecting to memory 804 and high-speed expansion ports 810, and a low-speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high-speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a computer-readable medium. In one implementation, the memory 804 is a volatile memory unit or units. In another implementation, the memory 804 is a non-volatile memory unit or units.

The storage device 806 is capable of providing mass storage for the computing device 800. In one implementation, the storage device 806 is a computer-readable medium. In various different implementations, the storage device 806 may be a hard disk device, an optical disk device, a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 804, the storage device 806, or memory on processor 802.

The high-speed controller 808 manages bandwidth-intensive operations for the computing device 800, while the low-speed controller 812 manages lower bandwidth-intensive operations. Such allocation of duties is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more computing devices 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a Microdrive or other device, to provide additional storage. Each of the components 850, 852, 864, 854, 866, and 868, are interconnected using various buses, and several of the components may be mounted on a common motherboard or in other manners as appropriate.

The processor 852 can process instructions for execution within the computing device 850, including instructions stored in the memory 864. The processor may also include separate analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD display or an OLED display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication (e.g., via a docking procedure) or for wireless communication (e.g., via Bluetooth or other such technologies).

The memory 864 stores information within the computing device 850. In one implementation, the memory 864 is a computer-readable medium. In one implementation, the memory 864 is a volatile memory unit or units. In another implementation, the memory 864 is a non-volatile memory unit or units. Expansion memory 874 may also be provided and connected to device 850 through expansion interface 872, which may include, for example, a SIMM card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using Bluetooth, WiFi, or other such transceivers (not shown). In addition, GPS receiver module 870 may provide additional wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.), and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or another similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus, and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication, such as, a communication network. Examples of communication networks include a local area network (“LAN”), a wide area network (“WAN”), and the Internet.

The computing system can include clients and servers. A client and server are generally remote from each other and typically interact through a communication network. The relationship between client and server arises by virtue of computer programs running on the respective computers and having a client-server relationship with each other.

As used in this specification, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

In addition to the embodiments described above, the following embodiments are also innovative:

Embodiment 1 is a method for training a reinforcement learning model, comprising: receiving data representing a computational graph, wherein the computational graph comprises a plurality of nodes and a plurality of directional edges, wherein each directional edge connects two neighboring nodes, wherein the plurality of nodes includes (i) one or more initial nodes that each correspond to a user query and does not have any preceding nodes and (i) one or more terminal nodes that each is associated with data corresponding to a user query and does not have with any succeeding nodes; receiving training data including a reward function for a reinforcement learning model; initializing a value function of the reinforcement learning model, wherein the value function is configured to generate a respective value for each pair of the node and a respective directional edge starting from the node and terminating in a corresponding terminal node in the computational graph; for each node that is not a terminal node in the plurality of nodes, determining a value function of the reinforcement learning model for the computational graph, comprising: updating the value function of the reinforcement learning model based on (i) a respective directional edge that starts from the node and connects a succeeding node and (ii) the reward function; determining that the updated value function converges; and in response to determining that the value function converges, providing the updated value function as the value function; and processing the user query using the computational graph based on the determined value function.

Embodiment 2 is the method of Embodiment 1, wherein processing a user query based on the determined value function comprising: receiving, from a user device, a user query that corresponds to an initial node in the computational graph; in response to receiving the user query, generating a particular trajectory, using the value function of the trained reinforcement learning model, in the computational graph for the user query that includes a plurality of nodes and starts from the initial node to a terminal node in the computational graph; and providing, to the user device, data associated with one or more nodes including the terminal node in the particular trajectory that correspond to the user query.

Embodiment 3 is the method of Embodiment 1 or 2, wherein updating the value function of the reinforcement learning model for the node further includes: generating, using the reward function, (1) an immediate reward for the node and the respective directional edge for the node and (2) a discounted reward for the succeeding node in the respective directional edge; and updating the value function based on the immediate reward and the discounted reward.

Embodiment 4 is the method of any one of Embodiments 1-3, further comprising determining the respective directional edge that starts from the node and connects a succeeding node, wherein the determining comprising: determining a plurality of candidate random walks for the node, where each candidate random walks goes from the node to a respective succeeding node along a different directional edge in the computational graph; sampling a random walk from the plurality of candidate random walks for the node based on the value function; and determining, as the respective directional edge, the edge based on the sampled random walk.

Embodiment 5 is the method of Embodiment 4, wherein updating the value function of the reinforcement learning model further includes: generating a score, using a scoring function of the reinforcement learning model, for the sampled random walk; generating, using the reward function, a discounted reward for the node in the directional edge; and updating the value function based on a weighted sum of the score and the discounted reward.

Embodiment 6 is the method of Embodiment 5, wherein the scoring function is based on a measure of similarity between the node and the respective succeeding node associated with the sampled random walk.

Embodiment 7 is the method of any one of Embodiments 2-6, wherein determining the particular trajectory comprises determining a sequence of directional edges in the particular trajectory, wherein each directional edge in the sequence is determined by operations comprising: for each node that is not the terminal node in the particular trajectory: determining a respective maximum value generated by the value function for the node; and selecting, based on the maximum value, an edge from a plurality of directional edges that start from the node as the directional edge.

Embodiment 8 is a system comprising one or more computers and one or more storage devices storing instructions that are operable, when executed by the one or more computers, to cause the one or more computers to perform the method of any one of embodiments 1-7.

Embodiment 9 is a computer storage medium encoded with a computer program, the program comprising instructions that are operable, when executed by data processing apparatus, to cause the data processing apparatus to perform the method of any one of embodiments 1 to 7.

Embodiment 10 is a method for processing a user query, comprising: receiving data representing a computational graph, wherein the computational graph comprises a plurality of nodes and a plurality of directional edges, wherein each directional edge connects two neighboring nodes, wherein the plurality of nodes includes (i) one or more initial nodes that each correspond to a user query and (i) one or more terminal nodes that each is associated with data corresponding to a user query; receiving data representing a particular user query; processing the particular user query to generate output data responsive to the particular user query using a particular Markov chain Monte Carlo algorithm based on weights assigned to the plurality of directional edges, wherein the weights are determined through training the particular Markov chain Monte Carlo algorithm using reinforcement learning; and providing the output data responsive to the particular user query to be displayed on a user device.

Embodiment 11 is the method of Embodiment 10, wherein processing the particular user query comprises: generating a trajectory including a sequence of edges of the plurality of edges by repeatedly sampling a random walk from a current node to a succeeding node, wherein the sampling is performed according to a probability distribution generated based on at least a subset of the weights assigned to the plurality of directional edges.

Embodiment 12 is the method of Embodiment 10 or 11, wherein training the particular Markov chain Monte Carlo algorithm using reinforcement learning comprises: determining initial weights for the plurality of directional edges based on user feedback information over historical output data provided for historical user queries, and updating the weights based on the initial weights by updating a value function.

Embodiment 13 is the method of Embodiment 12, wherein determining initial weights for the plurality of directional edges based on the user feedback information comprises: for each edge of the plurality of edges, determining a weighted sum of the user feedback information, wherein the user feedback information includes an occurrence of a type of user interaction with the historical output data provided for historical user queries, and wherein the type of user interaction includes clicking, adding to a cast, or purchasing a listing of an item represented in the historical output data.

Embodiment 14 is the method of Embodiment 12 or 13, wherein updating the value function comprises: receiving training data including a reward function; initializing the value function, wherein the value function is configured to generate a respective value for each pair of a node and a respective directional edge starting from the node and terminating in a corresponding terminal node in the computational graph; and for each node that is not a terminal node in the plurality of nodes, updating the value function for the computational graph based on (i) a respective directional edge that starts from the node and connects a succeeding node and (ii) the reward function repeatedly until determining that the value function converges.

Embodiment 15 is the method of Embodiment 14, wherein updating the value function for the node further comprises: generating a score for an edge sampled by the Markov chain Monte Carlo algorithm from a scoring function; generating, using the reward function, a discounted reward for the node in the sampled edge; and updating the value function based on a weighted sum of the score and the discounted reward.

Embodiment 16 is the method of any one of Embodiments 10-15, wherein the Markov chain Monte Carlo algorithm is the Metropolis-Hastings algorithm.

Embodiment 17 is a system comprising one or more computers and one or more storage devices storing instructions that are operable, when executed by the one or more computers, to cause the one or more computers to perform the method of any one of embodiments 10-16.

Embodiment 18 is a computer storage medium encoded with a computer program, the program comprising instructions that are operable, when executed by data processing apparatus, to cause the data processing apparatus to perform the method of any one of embodiments 10 to 16.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1.-20. (canceled)

21. A method for processing a user query, comprising:
receiving data representing a computational graph, wherein the computational graph comprises a plurality of nodes and a plurality of directional edges, wherein each directional edge connects two neighboring nodes, wherein the plurality of nodes includes (i) one or more initial nodes that each correspond to a user query and (i) one or more terminal nodes that each is associated with data corresponding to a user query;
receiving data representing a particular user query;
processing the particular user query to generate output data responsive to the particular user query using a particular Markov chain Monte Carlo algorithm based on weights assigned to the plurality of directional edges, wherein the weights are determined through training the particular Markov chain Monte Carlo algorithm using reinforcement learning; and
providing the output data responsive to the particular user query to be displayed on a user device.

22. The method of claim 21, wherein processing the particular user query comprises:
generating a trajectory including a sequence of edges of the plurality of edges by repeatedly sampling a random walk from a current node to a succeeding node, wherein the sampling is performed according to a probability distribution generated based on at least a subset of the weights assigned to the plurality of directional edges.

23. The method of claim 21, wherein training the particular Markov chain Monte Carlo algorithm using reinforcement learning comprises:
determining initial weights for the plurality of directional edges based on user feedback information over historical output data provided for historical user queries, and
updating the weights based on the initial weights by updating a value function.

24. The method of claim 23, wherein determining initial weights for the plurality of directional edges based on the user feedback information comprises:
for each edge of the plurality of edges, determining a weighted sum of the user feedback information, wherein the user feedback information includes an occurrence of a type of user interaction with the historical output data provided for historical user queries, and wherein the type of user interaction includes clicking, adding to a cast, or purchasing a listing of an item represented in the historical output data.

25. The method of claim 23, wherein updating the value function comprises:
receiving training data including a reward function;
initializing the value function, wherein the value function is configured to generate a respective value for each pair of a node and a respective directional edge starting from the node and terminating in a corresponding terminal node in the computational graph; and
for each node that is not a terminal node in the plurality of nodes, updating the value function for the computational graph based on (i) a respective directional edge that starts from the node and connects a succeeding node and (ii) the reward function repeatedly until determining that the value function converges.

26. The method of claim 25, wherein updating the value function for the node further comprises:
generating a score for an edge sampled by the Markov chain Monte Carlo algorithm from a scoring function;
generating, using the reward function, a discounted reward for the node in the sampled edge; and
updating the value function based on a weighted sum of the score and the discounted reward.

27. The method of claim 21, wherein the Markov chain Monte Carlo algorithm is the Metropolis-Hastings algorithm.

28. A system, comprising:
one or more memory devices storing instructions; and
one or more data processing apparatus that are configured to interact with the one or more memory devices, and upon execution of the instructions, perform operations including:
receiving data representing a computational graph, wherein the computational graph comprises a plurality of nodes and a plurality of directional edges, wherein each directional edge connects two neighboring nodes, wherein the plurality of nodes includes (i) one or more initial nodes that each correspond to a user query and (i) one or more terminal nodes that each is associated with data corresponding to a user query;
receiving data representing a particular user query;
processing the particular user query to generate output data responsive to the particular user query using a particular Markov chain Monte Carlo algorithm based on weights assigned to the plurality of directional edges, wherein the weights are determined through training the particular Markov chain Monte Carlo algorithm using reinforcement learning; and
providing the output data responsive to the particular user query to be displayed on a user device.

29. The system of claim 28, wherein processing the particular user query comprises:
generating a trajectory including a sequence of edges of the plurality of edges by repeatedly sampling a random walk from a current node to a succeeding node, wherein the sampling is performed according to a probability distribution generated based on at least a subset of the weights assigned to the plurality of directional edges.

30. The system of claim 28, wherein training the particular Markov chain Monte Carlo algorithm using reinforcement learning comprises:
determining initial weights for the plurality of directional edges based on user feedback information over historical output data provided for historical user queries, and
updating the weights based on the initial weights by updating a value function.

31. The system of claim 30, wherein determining initial weights for the plurality of directional edges based on the user feedback information comprises:
for each edge of the plurality of edges, determining a weighted sum of the user feedback information, wherein the user feedback information includes an occurrence of a type of user interaction with the historical output data provided for historical user queries, and wherein the type of user interaction includes clicking, adding to a cast, or purchasing a listing of an item represented in the historical output data.

32. The system of claim 30, wherein updating the value function comprises:
receiving training data including a reward function;
initializing the value function, wherein the value function is configured to generate a respective value for each pair of a node and a respective directional edge starting from the node and terminating in a corresponding terminal node in the computational graph; and
for each node that is not a terminal node in the plurality of nodes, updating the value function for the computational graph based on (i) a respective directional edge that starts from the node and connects a succeeding node and (ii) the reward function repeatedly until determining that the value function converges.

33. The system of claim 32, wherein updating the value function for the node further comprises:
generating a score for an edge sampled by the Markov chain Monte Carlo algorithm from a scoring function;
generating, using the reward function, a discounted reward for the node in the sampled edge; and
updating the value function based on a weighted sum of the score and the discounted reward.

34. The system of claim 28, wherein the Markov chain Monte Carlo algorithm is the Metropolis-Hastings algorithm.

35. A non-transitory computer readable medium storing instructions that, when executed by one or more data processing apparatus, cause the one or more data processing apparatus to perform operations comprising:
receiving data representing a computational graph, wherein the computational graph comprises a plurality of nodes and a plurality of directional edges, wherein each directional edge connects two neighboring nodes, wherein the plurality of nodes includes (i) one or more initial nodes that each correspond to a user query and (i) one or more terminal nodes that each is associated with data corresponding to a user query;
receiving data representing a particular user query;
processing the particular user query to generate output data responsive to the particular user query using a particular Markov chain Monte Carlo algorithm based on weights assigned to the plurality of directional edges, wherein the weights are determined through training the particular Markov chain Monte Carlo algorithm using reinforcement learning; and
providing the output data responsive to the particular user query to be displayed on a user device.

36. The computer readable medium of claim 35, wherein processing the particular user query comprises:
generating a trajectory including a sequence of edges of the plurality of edges by repeatedly sampling a random walk from a current node to a succeeding node, wherein the sampling is performed according to a probability distribution generated based on at least a subset of the weights assigned to the plurality of directional edges.

37. The computer readable medium of claim 35, wherein training the particular Markov chain Monte Carlo algorithm using reinforcement learning comprises:
determining initial weights for the plurality of directional edges based on user feedback information over historical output data provided for historical user queries, and
updating the weights based on the initial weights by updating a value function.

38. The computer readable medium of claim 37, wherein determining initial weights for the plurality of directional edges based on the user feedback information comprises:
for each edge of the plurality of edges, determining a weighted sum of the user feedback information, wherein the user feedback information includes an occurrence of a type of user interaction with the historical output data provided for historical user queries, and wherein the type of user interaction includes clicking, adding to a cast, or purchasing a listing of an item represented in the historical output data.

39. The computer readable medium of claim 37, wherein updating the value function comprises:
receiving training data including a reward function;
initializing the value function, wherein the value function is configured to generate a respective value for each pair of a node and a respective directional edge starting from the node and terminating in a corresponding terminal node in the computational graph; and
for each node that is not a terminal node in the plurality of nodes, updating the value function for the computational graph based on (i) a respective directional edge that starts from the node and connects a succeeding node and (ii) the reward function repeatedly until determining that the value function converges.

40. The computer readable medium of claim 39, wherein updating the value function for the node further comprises:
generating a score for an edge sampled by the Markov chain Monte Carlo algorithm from a scoring function;
generating, using the reward function, a discounted reward for the node in the sampled edge; and
updating the value function based on a weighted sum of the score and the discounted reward.

41. (canceled)
